(19) United States
(12) Patent Application Publication
(10) Pub. No.: US 2008/0245261 A1
(43) Pub. Date: Oct. 9, 2008

(54) Dry Additive for Hydraulic Binders

(75) Inventors: Benedikt Lindlar, Konstanz (DE); Andre Schiegg, Obfelden (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 10/581,900

(22) PCT Filed: Dec. 23, 2004
(86) PCT No.: PCT/EP2004/053698

§ 371 Date: Sep. 13, 2007

(30) Foreign Application Priority Data
Dec. 23, 2003 (EP) 03029596.8

(51) Int. Cl. C04B 14/00

(52) U.S. Cl. 106/14.44; 106/400; 106/672; 106/677

(57) ABSTRACT

The invention relates to a dry additive for hydraulic binders, and to the production and use thereof. The solid additive is characterized by comprising a liquid additive (1) disposed in a microporous carrier (2). The inventive additive allows for the formulation of hydraulically curing compositions (3) which have a substantially better storage stability than the corresponding hydraulic composition to which the liquid additive (1) was directly added. The invention also relates to a method for the rehabilitation of cured hydraulic compositions such as concrete, and therefore to the possibility of corrosion protection of concrete steel in already cured hydraulic compositions.

### INDUSTRIAL FIELD

The invention relates to dry additives for hydraulic binders.

### STATE OF THE ART

Dry additives for hydraulic binders are sold alone or also already mixed in, e.g. as dry concrete or dry mortar. Such dry mixtures have relatively good storage stability and storage life, since with mixtures of dry raw material powders no interactions between the raw materials which affect the storage properties occur during the storage period.

However, when liquid raw materials or additives are to be added to the dry mixture, for example by injecting or pouring an additive into the powder mixture, the storage time during which the powder mixture retains its desired properties is drastically reduced. Even carriers which adsorb the liquid on their surface are not always suitable for preventing interactions, however, this is dependent on the properties of the liquid additive. In particular, hydrophilic liquids with significant vapor pressure can migrate into the powder mixture and cause undesired effects.

### PRESENTATION OF THE INVENTION

The invention is based on the objective of attaining adequate storage stability with a dry additive for hydraulic binders of the type mentioned at the outset even with the use of at least one liquid additive.

According to the invention, this is achieved through the features of the first claim.

The advantages of the dry additive according to the invention consist on the one hand in that the dry additive is storage-stable and simple to dose, and in particular in that hydraulically curing composition formulated therewith have substantially better storage stability than a similar composition into which the corresponding liquid additive was mixed in the liquid state.

A further advantage consists in that during working the liquid additive absorbed in the microporous carrier is only released, with a delay, with the addition of water, and migrates into the hydraulic binder, or into the matrix.

Moreover, a further advantage should be mentioned, namely that a corrosion-inhibiting additive protects reinforcing iron present in a hardened hydraulic composition from corrosion.

Moreover, within certain limits the kinetics of release can be influenced through appropriate combination of the microporous carrier and the liquid additive.

Further advantageous forms of the invention follow from the subclaims.

### BRIEF DESCRIPTION OF THE DRAWING

The invention is explained in more detail below on the basis of the drawings. The same components in the different figures are given the same reference symbols.

FIG. 1: shows a schematic view of a microporous carrier loaded with a liquid additive;

FIG. 2: shows a schematic view of a hydraulically curing composition containing a microporous carrier loaded with a liquid additive;

FIG. 3: shows a schematic view of a hardened hydraulic composition and a hydraulically curing composition used for rehabilitation purposes containing a microporous carrier loaded with a liquid additive.

### IMPLEMENTATION OF THE INVENTION

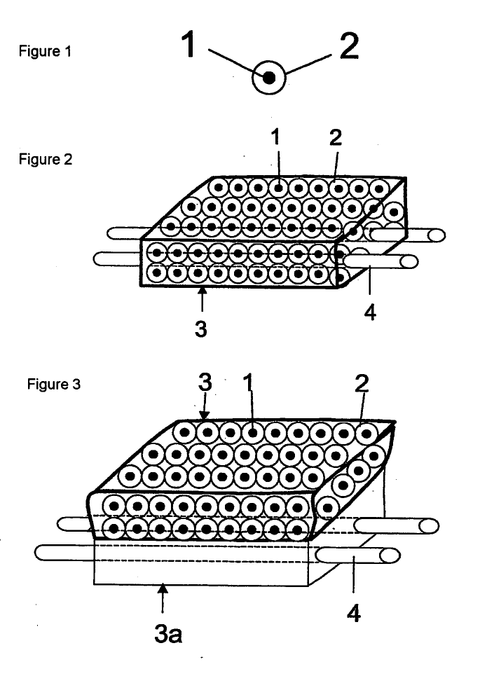

FIG. 1 shows a microporous carrier 2 loaded with at least one liquid additive 1. For this, the microporous carrier 2 is mixed with the liquid additive 1 in a dry mixer.

Suitable microporous carriers 2 are microporous molecular sieves, preferably zeolites, in particular synthetic zeolites.

The microporous structure of the carrier 2 is characterized by a pore system of defined pore radius and specific pore surface area. Depending on the desired structure, larger cavities are connected by this pore system. This property enables the directed adsorption of molecules on the basis of molecular size and polarity.

Thus microporous molecular sieves are possible as carriers, in particular zeolites. Zeolites can be produced synthetically or occur naturally in formerly volcanic areas, where they are extracted by open-cast mining, for example in Italy.

Commercial zeolites have pore diameters that usually lie in a range from 3 to 10 Angström (10⁻¹⁰ m), preferably between 4 and 8 Angström, but can also be larger.

Preferably the microporous carriers are in powder form, in particular with a mean particle diameter of less than 100 micrometers, preferably between 100 and 10 micrometers, most preferably between 50 and 25 micrometers. In production, zeolites are obtained as a very fine powder and are sometimes processed into coarser particles with a binder. However, for use as microporous carriers, zeolites as powder are preferred. A possible pretreatment is partial saturation of the zeolites with water. This is particularly advantageous in the present invention, in order to simplify the impregnation with the liquid additive.

Zeolites of the type zeolite A, Linde Type A (LTA) are particularly preferred. Still more preferred are cation-exchanged zeolites without, or at least largely without, alkali metal ions.

By variation of the aluminum/silicon ratio, the hydrophilicity and hydrophobicity can be controlled. This property can be used in order to select or adjust the suitability of a specific zeolite for the liquid additive used.

In order to incorporate the additive in the carrier, the carrier is introduced into a dry mixer and the liquid additive is added with a nozzle and stirred in the mixer.

The content of the liquid additive 1 relative to the carrier 2 normally lies in a range of up to 100 wt. % of the carrier, in particular from 10 to 80 wt. %. This is however also dependent on the nature of the zeolites used and their parameters.

Depending on the use and/or nature of the additive, it can be advantageous not completely to exhaust the capacity for physical and chemical loading of the microporous carrier with the liquid additive.

The carrier 2 loaded with the liquid additive 1 is dry and storage-stable for at least one year.

As additive 1, any liquid concrete additives can be used. The use of accelerators, corrosion inhibitors, liquefiers, retardants, shrinkage reducers, antifoaming agents and the like is advantageous. The use of the aforesaid additives is however limited by the kinetics of release from the carrier. The material of the carrier, in particular its pore size and composition, is preferably selected such that the kinetics of release is matched to the function of the additive. For example, a rapid release is desirable for a liquefier or antifoaming agent, while for a corrosion inhibitor a retarded release is advantageous.

The microporous carrier loaded with an additive can be a component of a dry hydraulically setting composition, without affecting the storage stability of this mixture. The microporous carrier loaded with the additive can be present in a hydraulically setting composition in a quantity of 0.05 to 50 wt. %, preferably in a quantity of 0.05 to 20 wt. %. The hydraulically setting composition further contains at least one hydraulic binder. The hydraulic binder contains at least one cement, in particular at least one cement according to Euronorm EN 197 or calcium sulfate, in the form of anhydrite, hemihydrate or dihydrate gypsum, or calcium hydroxide. Portland cements, sulfoaluminate cements and high alumina cements, in particular Portland cement, are preferable. Mixtures of cements can result in particularly good properties. For rapid curing, cementous rapid binders are mainly used, which preferably contain at least one high alumina cement or another aluminum source, such as for example aluminate-donating clinker, and optionally calcium sulfate, in the form of anhydrite, hemihydrate or dihydrate gypsum, and/or calcium hydroxide. Cement, in particular Portland cement, is preferred as a component of the hydraulic binder.

The dry, hydraulically setting composition powder thus obtained is then storage-stable essentially for as long, or at least 90% as long, as the corresponding hydraulically setting composition without the dry additive according to the invention, usually corresponding to a period of 12 to 15 months.

In principle, through the selection of suitable zeolites with different cations, e.g. H⁺, Na⁺, K⁺ and Ca²⁺, the adsorption and release behavior and possible effects on the cementous mixture can be influenced.

The hydraulically setting composition can for example be a ready-mixed mortar, a repair mortar, a dry-mix mortar or a concrete.

This hydraulically setting composition has a storage stability which is markedly improved compared to the same hydraulically setting composition which is treated directly with the liquid additive used for the production of the dry additive instead of with the dry additive.

Here, storage stability means that the water/cement ratio remains the same ±3% in order to achieve the same application properties as before the storage.

For the working of the dry hydraulically setting composition, a required quantity of water is added and the mixture processed. The quantity of water required is first and foremost determined on the basis of the water/cement ratio normally used by the skilled person. Through the working and the cement setting reaction, the liquid additive 1 is released from the pore structure of the carrier 2 and the additive 1 migrates into the hydraulic binder. The rate of release of the additive here is adjusted depending on the nature of the additive, and can also take place with a delay. After the contact with water, the hydraulically setting composition cures.

FIG. 2 schematically shows a hydraulically setting composition with a microporous carrier 2 which is loaded with a liquid additive 1. The additive here is a corrosion-inhibiting liquid additive 1. Here the release will preferably take place slowly, in order to protect the reinforcing iron 4 present in the hydraulically setting composition 3 from corrosion.

As corrosion inhibitors, for example alkanolamines, alcohols, organic acids or phosphonates can be used. As alkanolamines, ethanolamine or N-alkylated ethanolamines are suitable, preferably selected from the group comprising monoethanolamine, diethanolamine, triethanolamine, N-methyldiethanolamine, N,N-dimethylethanolamine and mixtures thereof.

Particularly preferably, monoethanolamine (MEA) is used.

FIG. 3 shows the rehabilitation of a cured hydraulic composition 3a, e.g. a concrete, with a hydraulically setting composition 3, e.g. a mortar. The cured hydraulic composition to be repaired, 3a, which is carbonatized, chloride-contaminated, friable, pitted or fissured and/or has reinforcing iron 4 visible in certain places, can be prepared by dressing the surface, for example by chipping or knocking off with a hammer or similar means, in particular until intact concrete is encountered. Hereupon, the hydraulically setting composition is mixed with water and applied to the cured hydraulic composition 3a. During the working of the hydraulically setting composition 3, the liquid additive 1 is released, preferably with a delay, and migrates into the hydraulically setting composition 3 and then into the cured hydraulic composition 3a, for example the concrete. If the liquid additive 1 present in the carrier 2 is a corrosion inhibitor, the additive is absorbed on the reinforcing iron 4, which results in corrosion protection. Depending on the use and nature of the additive, it can be advantageous that the liquid additive is released before, during or after application.

This method therefore represents a possible way in which reinforcing iron in already cured hydraulic compositions can be protected against corrosion.

### EXAMPLES

The invention is now explained in more detail on the basis of examples. These examples are intended further to illustrate the invention, but in no way restrict the scope of the invention.

1. Dry Additives

As examples B1, B2 and B3 of a microporous carrier 2, the zeolites

| | | Pore | Crystal | | |
|---|---|---|---|---|---|
| | Cation | size | size | Nature | Miscellaneous |
| B1 | Na⁺ | 7.5 Å | 2 μm | hydrophilic | water adsorption (20° C., |
| | | | | | 55% rel. atm. humidity): |
| | | | | | 29% |
| B2 | H⁺ | 7.5 Å | | hydrophobic | |
| B3 | H⁺ | 5.5 Å | 0.2-1 μm | hydrophobic | surface area |
| | | | | | (BET) >300 m²/g |

were each treated with 10, 20 and 50 wt. %, based on the weight of the carrier, of monoethanolamine (MEA) (commercially available from Fluka Chemie, Switzerland) as a liquid additive and homogenized by simple mixing in a dry mixer.

Next, the pourability and the odor were assessed by eye or nose according to the scale shown in Table 1, and compared in Table 2.

TABLE 1
Assessment of pourability and odor.

| | − | ∘ | + | ++ |
|---|---|---|---|---|
| Pourability | poor | medium | good | very good |
| | severe lumping | slight | no lumping | no lumping |
| | | lumping | | |
| Odor | very strong | strong | slight | none |
| | very disturbing | disturbing | slightly | not |
| | | | disturbing | disturbing |

TABLE 2
Dry additives.

| | Carrier material | B1 | B2 | B3 |
|---|---|---|---|---|
| 10% MEA | | B1-10 | B2-10 | B3-10 |
| | Pourability | ++ | ++ | ++ |
| | Odor | ++ | ++ | ++ |
| 20% MEA | | B1-20 | B2-20 | B3-20 |
| | Pourability | ++ | + | ++ |
| | Odor | ++ | − | ++ |
| 50% MEA | | B1-50 | B2-50 | B3-50 |
| | Pourability | ∘ | + | ∘ |
| | Odor | − | ∘ | −− |

2. Hydraulically Setting Compositions

0.5 g of B1-20 were mixed into 100 g of SikaQuick™ 506 (commercially available from Sika Schweiz AG)—as an example of a dry hydraulically setting composition. As a reference R1 and R2, 0.083 g of MEA were mixed with 100 g of SikaQuick™ 506.

These three samples and a sample of SikaQuick™ 506 were stored in a closed drum for 180 days at room temperature, and then mixed with water as per EN 480-1 and assessed. The reference R3 was made by mixing the stored sample of SikaQuick™ 506 with mixing water to which 0.091 g of MEA per 100 g of SikaQuick™ 506 had been added.

The samples were assessed on the basis of the following parameters:
air content measured as in EN 12350-7 (concrete testing)
spreading measured after 10 mins and 15 blows as per DIN 18555-2
working: assessment of cohesion and viscosity by the skilled person
compression strength after 28 days' curing at 23° C. and 50% rel. atm. humidity as per EN 196-1
bending tensile strength after 28 days' curing at 23° C. and 50% rel. atm. humidity as per EN 196-1
drying shrinkage after 91 days at 23° C. and 50% rel. atm. humidity as per DIN 52450

TABLE 3
Properties of hydraulic compositions

| | R1 | R2 | R3 | B1-20 |
|---|---|---|---|---|
| Mixing water [wt. %] | 16.5 | 17 | 15 | 15 |
| Air content [%] | 5.2 | 5.2 | 6.0 | 5.6 |
| Spreading [mm] | 135 | 149 | 145 | 148 |
| Workability | too stiff | good | good | good |
| Compression strength [MPa] | 28.4 | 22.9 | 32.7 | 33.1 |
| Bending tensile strength [MPa] | 5.7 | 5.5 | 7.2 | 7.0 |
| Drying shrinkage [mm/m] | | −1.44 | −1.25 | −1.26 |

Table 3 shows the results of this assessment. It is thus clear that in contrast to the addition of the liquid additive (R1 and R2), the addition of the solid additive (B1-20) does not worsen the storage stability of the hydraulically setting composition, as is clear from the comparison with R3. The examples R1 and R2 require a considerably higher water content in order to obtain the same workability, in particular spreading. However, a higher water demand has an adverse effect on the mechanical properties, and the shrinkage and hence also on the permeability.

Furthermore, it, was observed that the strength and shrinkage values for B1-20 are comparable with the reference R3, in fact after storage, or without storage. In addition, compared to B1-20, the references R1 and R2 showed markedly worsened shrinkage and strength values and markedly increased permeability after storage.

### LIST OF SYMBOLS

1 liquid additive
2 microporous carrier
3 hydraulically setting composition
3a cured hydraulic composition
4 reinforcing iron

1. A dry additive for hydraulic binder, comprising a liquid additive disposed in a microporous carrier.

2. The dry additive as claimed in claim 1, wherein the liquid additive is a liquefier, accelerator, retardant, antifoaming agent, shrinkage reducer or a corrosion inhibitor.

3. The dry additive as claimed in claim 2, wherein the liquid additive is a corrosion inhibitor.

4. The dry additive as claimed in claim 1, wherein the microporous carrier is a molecular sieve.

5. The dry additive as claimed in claim 4, wherein the microporous carrier is present in powder form.

6. The dry additive as claimed in claim 1, wherein the microporous carrier has a pore diameter between 3 and 10 Angström.

7. The dry additive as claimed in claim 1, wherein the carrier loaded with the liquid additive has a storage stability of more than one year.

8. A hydraulically setting composition containing a dry additive as claimed in claim 1 and a hydraulic binder.

9. The hydraulically setting composition as claimed in claim 8, wherein the hydraulic binder contains a cement.

10. The hydraulically setting composition as claimed in claim 8, wherein the storage stability is as long as that of the corresponding hydraulically setting composition without said dry additive.

11. The hydraulically setting composition as claimed in claim 8, wherein the hydraulically setting composition is a ready-mixed mortar, a repair mortar, a dry-mix mortar or a concrete.

12. A cured hydraulic composition obtained by the curing of a hydraulically setting composition as claimed in claim 8 by means of water.

13. A process for the release of a liquid additive from a dry additive as claimed in claim 1, wherein the dry additive is brought into contact with water.

14. A process for making a hydraulic composition, comprising mixing the dry additive as claimed in claim 1 with a hydraulic binder.

15. A process for the production of a dry additive as claimed in claim 1, wherein a liquid additive is mixed into a microporous material and stirred.

16. A process for the rehabilitation of a cured hydraulic composition comprising the steps
a) mixing of a hydraulically setting composition as claimed in claim 8 with water,
b) release of the liquid additive,
c) application of the hydraulic composition mixed with water onto the cured hydraulic composition,
d) migration of the liquid additive into the cured hydraulic composition, wherein the steps b) and c) can also take place at the same time or in reverse order.

17. The process for rehabilitation as claimed in claim 16, wherein the liquid additive is a corrosion inhibitor.

18. The process for rehabilitation as claimed in claim 16, wherein the cured hydraulic composition contains reinforcing iron.

19. The process for rehabilitation as claimed in claim 18, wherein the corrosion inhibitor migrates through the cured hydraulic composition and is absorbed onto the reinforcing iron.

20. The dry additive as claimed in claim 4, wherein the microporous carrier has a pore diameter between 3 and 10 Angström.

21. The dry additive as claimed in claim 5, wherein the microporous carrier has a pore diameter between 3 and 10 Angström.

22. The dry additive as claimed in claim 3, wherein the liquid additive is selected from the group consisting of an alkanolamine, an alcohol, an organic acid, and a phosphonate.

23. The dry additive as claimed in claim 3, wherein the liquid additive is mono-ethanol amine.

24. The dry additive as claimed in claim 4, wherein the microporous carrier is zeolites.

25. The dry additive as claimed in claim 4, wherein the microporous carrier is a zeolite A, Linde Type A (LTA).

26. The dry additive as claimed in claim 5, wherein the microporous carrier is present in powder form with a mean particle diameter of between 50 and 25 micrometers.
